(19) United States
(12) Patent Application Publication
(10) Pub. No.: US 2010/0209573 A1
(43) Pub. Date: Aug. 19, 2010

(54) GRANULATED SEASONING SALT AND PREPARATION METHOD THEREOF

(75) Inventors: Mi Na Jo, Seoul (KR); Min Kyung Lee, Seoul (KR); Won Dae Chung, Seoul (KR); Jun Bong Choi, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: CJ CHEILJEDANG CORPORATION, Seoul (KR)

(21) Appl. No.: 12/705,541

(22) Filed: Feb. 12, 2010

Related U.S. Application Data
(63) Continuation of application No. PCT/KR2008/001116, filed on Feb. 26, 2008.

(30) Foreign Application Priority Data
Aug. 24, 2007 (KR) 10-2007-0085729

(51) Int. Cl. A23L 1/237; A23P 1/02

(52) U.S. Cl. 426/285; 426/649

(57) ABSTRACT

The present invention relates to a granulated seasoning salt and a preparation method thereof, characterized by using a gelatinized tapioca starch solution as a binder and an anti-caking agent. The granulated seasoning salt according to the present invention is prepared by using a gelatinized tapioca starch solution as a binder and an anti-caking agent to solve the problem such as caking property due to moisture absorption. Thus, the prepared seasoning salt has high binding capacity and stability, does not turn brown, is rapidly eluted, and can be stored for a long period of time without dissociation of the mixed materials.

### TECHNICAL FIELD

The present invention relates to a granulated seasoning salt and a preparation method thereof, characterized by using a gelatinized tapioca starch solution as a binder and an anti-caking agent.

### BACKGROUND ART

Salt, also called edible salt, has the chemical name of sodium chloride (NaCl), and is widely used in food seasoning and making salted foods at home as well as in the chemical industry such as manufacture of soda (sodium carbonate).

Salt is in cubic form having a density of 2.16, and when it is dissolved in water, all of the dissolved material is present as sodium (Na⁺) and chloride (Cl⁻) ions. That is, salt is a strong electrolyte that completely dissociates into ions in water. Salt has a melting point of 800° C. and is vaporized at 1,400° C. In 100 g of water, 35.7 g is dissolved at 0° C. and 39.8 g at 100° C. Since salt has a property of freezing point depression, its saturated solution is stable to −21.2° C. High concentrations of salt exhibit antiseptic and antimicrobial effects against most microorganisms, except for halophiles, and cause osmotic dehydration. In particular, salt is one of the essential elements for maintaining life, occupying about 0.9% by weight of body blood, and 0.1˜0.5% by weight of extracellular fluids such as sweat, tears, and urine, and creates a difference in osmotic pressure to regulate fluid balance. Thus, oxygen and nutrients in blood are transported to cells and waste products are excreted from cells to blood. In addition, salt in the body generates a potential difference for signal transmission in nerve cells, and dissociates into a chloride (Cl⁻) ion which is involved in the production of gastric juice and red blood cells. Therefore, the lack of salt can lead to digestive disorders, dizziness, and anemia

However, long-term excessive salt intake causes acidification of blood to increase viscosity, leading to thrombosis, arteriosclerosis, and hypertension. Even though excessive salt intake causes such problems, it is still hard to reduce salt intake, because salt enhances the flavor of food, and stimulates the appetite. High salt intake leads to a significant increase in the risk of hypertension, nephritis, gastritis, gastric cancer, diabetes, thereby receiving much public attention as social problems.

As such, salt is used only to control food salinity, and does not have other functions of providing various tastes and nutrients.

Accordingly, to provide various tastes and nutrients, many trials have been made to add natural vegetable ingredients to salt, in particular, the ingredients of garlic and green tea, of which useful physiological activities are well known.

Garlic is known to have antimicrobial and restorative effects, and show excellent effects on beriberi, pertussis, and tuberculosis. In addition, garlic is reported to have cardiotonic, antioxidant, anticancer, and antiviral effects. Garlic contains 1% essential oil which is responsible for the typical garlic flavor and odor, 5% polysaccharide, vitamin B₁ and C, or the like. The colorless, odorless allin is one of the essential oils, and converted to allicin by allinase to generate the garlic odor. It is reported that allicin has a powerful antioxidant effect on active oxygen species, thereby preventing arteriosclerosis, aging or the like. Allicin binds with vitamin B1, and then is converted into allithiamine which is not affected by enteric bacteria, and in turn facilitates vitamin B1 absorption. Generally, absorption of vitamin B₁ itself by the human body does not exceed 100 mg, but allithiamine is more readily absorbed to increase total absorption of vitamin B₁ by 2,000 mg. Thus, glucose, lipid, and carbohydrate metabolism is actively promoted. However, in spite of such advantages, most of people are so put off by its typical strong odor and flavor that they do not take garlic seriously.

On the other hand, green tea has been attracting much attention as a natural functional food, since it has health benefits such as control of biorhythms, immune enhancement, disease prevention and recovery, and aging prevention. In particular, catechin, one of the major ingredients of green tea, has a protective effect against many adult diseases including cancer, and inhibitory effects on AIDS virus, dental caries, and cholesterol level. Catechin is also known to prevent hypertension or arteriosclerosis, suppress lipoperoxide formation to delay aging, prevent obesity, and increase resistance of capillary vessel.

Garlic salt is not preferred by consumers due to its typical garlic flavor and odor. Thus, to solve the problem, the preparation method of odorless garlic is disclosed in Korean Patent No. 10-92818. The typical garlic odor is reduced by the method. However, garlic is immersed in boiled saline water for 3˜5 min, leading to lack of storage stability, unlike fresh garlic.

A method of manufacturing salt by a simple and clean process and a concentration apparatus for manufacturing garlic salt containing natural minerals are disclosed in Korean Patent Application No. 10-2003-12055. However, the method has a problem that the garlic salt tastes strongly bitter due to other ingredient contained in sea water, and the effective ingredients of garlic are not sufficiently eluted during the process of concentrating a mixture of sea water and garlic at 80° C.

In Korean Patent Application No. 10-2002-62887, disclosed are a common salt composition containing garlic ingredients and a manufacturing method thereof, comprising the step of dissolving edible salt in drinking water to prepare a saline solution at a 15˜50% concentration; sequentially immersing at least one of porous bags packed with each of garlic and mushrooms in the saline solution; and heating the porous bags immersed in the saline solution at 100˜120° C. to form precipitates. However, the method has a problem that the garlic salt obtained by the method is hardly dried, and after drying, the garlic salt absorbs moisture to form a lump.

In Korean Patent No. 10-513249, disclosed is a manufacturing method of garlic salt, in which garlic is mixed with 10˜90% by weight of drinking water containing a silver ion of 6˜10 ppm in a saline solution, and heated at 100˜120° C. to form precipitates. In Korean Patent No. 10-584782, disclosed is a method for preparing composite flavoring materials of garlic bamboo salt or garlic salt.

In addition, as an example of green tea salt which is prepared by binding salt with ingredients of green tea, a preparation method of green tea salt is disclosed in Korean Patent Application No. 10-2002-12455, in which a ground sun-dried salt is mixed with a green tea extract to put into a bamboo bucket, and then heated in a kiln eight times, and heated using a pine resin powder in a furnace at 1000° C. to melt the mixture. However, the active ingredient of green tea, catechin turns to ashes, and is inactivated by heating according to the method. The method also has a physical problem that the prepared green salt turns brown or black.

In Korean Patent Application No. 10-2002-11951, disclosed is a manufacturing method of processed salt containing the ingredients of green tea, in which a processed salt is prepared, pulverized, and then mixed with green tea powder at a predetermined ratio. However, the processed salt prepared by the method is simply prepared by physically mixing the pulverized salt with green tea powder.

In addition, a manufacturing method of green tea salt, a functional green salt and manufacturing methods thereof, and a functional green tea salt and a method of preparing the same are disclosed in Korean Patent Nos. 10-521341, 10-541286, and 10-639915, respectively.

As mentioned above, there are many studies on the garlic salt and green tea salt. However, the methods have problems that the ingredients of garlic or green tea are simply mixed with salt by a physical method or by using water as a binder and an anti-caking agent, so as to reduce their binding capacity, and thus they does not homogeneously mixed with each other and are easily dissociated. In addition, when gums such as guar gum, xanthan gum, and gellan gum are used as the binder and anti-caking agent, binding capacity is decreased to form a lump, high costs are required, and fungal contamination is generated. The conventional garlic salts and green tea salts also tend to turn brown on exposure to light.

Accordingly, there is a need for the development of seasoning salts, which have no caking and water absorption properties, do not turn brown, and have improvement in problems such as the lack of taste due to simple mixing of pulverized raw materials, and dissociation of mixed materials.

Accordingly, the present inventors have made intensive studies to solve the problems, and thus they prepared a seasoning salt by using a gelatinized tapioca starch solution as a binder and an anti-caking agent and various granulation methods. They found that the prepared seasoning salt does not turn brown, is rapidly eluted, and can be stored for a long period of time without dissociation of the mixed materials, thereby completing the present invention.

### DISCLOSURE

### Technical Problem

The present invention provides a granulated seasoning salt and a preparation method thereof, characterized by using a gelatinized tapioca starch solution as a binder and an anti-caking agent.

### Technical Solution

It is an object of the present invention to provide a granulated seasoning salt comprising a gelatinized tapioca starch solution.

### ADVANTAGEOUS EFFECTS

The granulated seasoning salt according to the present invention is prepared by using a gelatinized tapioca starch solution as a binder and an anti-caking agent to solve the problem such as caking property due to moisture absorption. Thus, the prepared seasoning salt has high binding capacity and stability, does not turn brown, is rapidly eluted, and can be stored for a long period of time without dissociation of the mixed materials. In addition, by adding active ingredients such as garlic and green tea to the salt, simultaneous intake of garlic and salt is simply accomplished by use of the garlic salt, and simultaneous intake of catechin is simply accomplished by use of the green tea salt. The granulated seasoning salt according to the present invention can be prepared into various types of granulated seasoning salts by using sea tangle, mushroom, onion, mugwort, pine needle, lemon or medicinal herbs, in addition to the active ingredient of garlic or green tea.

### DESCRIPTION OF DRAWINGS

FIG. 1 is a flow chart showing the preparation method of fluidized bed-granulated seasoning salt;

FIG. 2 is a flow chart showing the preparation method of lodige mixer-granulated seasoning salt;

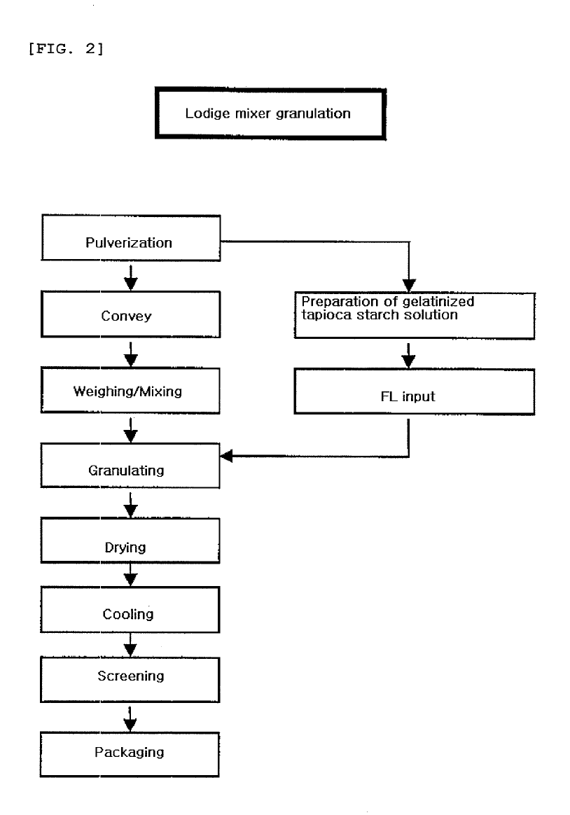

FIG. 3 is a flow chart showing the preparation method of extrusion-granulated seasoning salt;

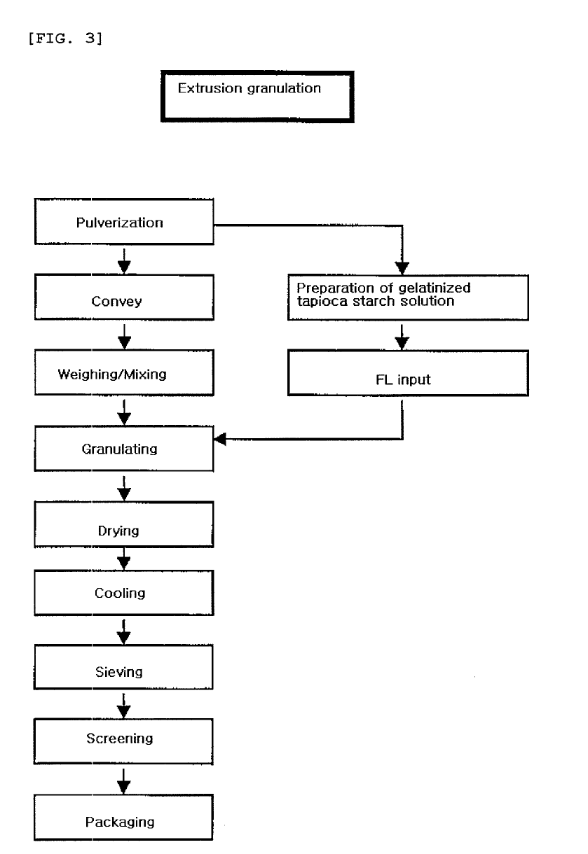

FIG. 4 shows the changes in color of granulated garlic seasoning salt in a glass bottle, which was measured after storing the opened bottle at 0 and 55° C. for 14 days; and

FIG. 5 shows the changes in color of granulated green tea seasoning salt in a glass bottle, which was measured after storing the opened bottle at 0 and 55° C. for 14 days.

### BEST MODE

The granulated seasoning salt includes a granulated garlic salt or a granulated green tea salt.

The tapioca starch is highly purified from a cassava powder by removing crude fiber, crude protein, and crude ash therefrom. The tapioca starch is easily absorbed and swollen by heating, and its gelatinized solution is highly viscous, transparent, and has low retrogradation tendency. In addition, whereas other starches are affected by edible salt to lose swelling power, absorption capacity and transparency, the tapioca starch is not greatly affected by edible salt. Thus, the tapioca starch can be used as a binder and an anti-caking agent in the present invention.

Generally, as the surface area of powdered raw material increases, strong cohesiveness and caking are generated, which causes fluidity and physical problems during food processing. To solve the problems, the powder having a small particle size is agglomerated into a granulation form, thereby reducing caking tendency. Thus, as granulation molding techniques used in food industry, employed is an agglomeration method or an extrusion granulation method which is a method for granulating a wet food by extrusion through uniform-sized pores using granulation molding apparatus. A granulation method using a fluidized bed dryer is very efficient in terms of operation or food sanitation, and can be performed by one apparatus to have functions of blending, granulating, and drying. Also, the method has a function of readily controlling the size and strength of fine particle. The granulation method of fine powder using a fluidized bed dryer is widely used in food and pharmaceutical industries.

In addition, the present invention provides a preparation method of the granulated seasoning salt, comprising the steps of

1) pulverizing refined salt, sugar or the like by supplying them to a mill;

2) mixing powered raw materials (a small amount of input raw material) with the pulverized refined salt, sugar or like;

3) preparing a gelatinized tapioca starch solution;

4) mixing a liquid material of garlic or green tea extract liquid with the gelatinized tapioca starch solution; and

5) granulating and drying the materials.

Hereinafter, the preparation method of the present invention will be described in detail.

In step 1), the refined salt, sugar or the like are finely pulverized to at least 90% passage through an 80 mesh.

Step 2) is a step of mixing the powdered materials of seasoning salt. The powdered materials of garlic seasoning salt and green tea seasoning salt are prepared as follows.

For the preparation of garlic seasoning salt, a peeled onion is sliced, dried and sterilized, and then 25% of the dried onion is mixed with 75% of tapioca starch, followed by pulverization to at least 90% passage through a 60 mesh, so as to prepare an onion mixed powder. The prepared onion mixed powder is a light yellow powder with a typical onion flavor. If the content of the dried onion is higher than 25%, caking occurs upon pulverization. If the content of the dried onion is lower than 25%, onion flavor is reduced.

A peeled garlic is sliced, dried and sterilized, and then 50% of the dried garlic is mixed with 50% of tapioca starch, followed by pulverization to at least 90% passage through a 60 mesh, so as to prepare a garlic mixed powder. The prepared garlic mixed powder is a light yellow powder with a typical garlic flavor. If the content of the dried garlic is higher than 50%, caking occurs upon pulverization. If the content of the dried onion is lower than 50%, garlic flavor is reduced.

A seasoning pepper powder is prepared by pulverizing each refined material to pass through a 30 mesh, and then mixing 5% of oleoresin black pepper, 0.4% of oleoresin capsicum with 30% of corn starch and 64.6% of glucose as excipients for 60 min.

The tapioca starch is prepared as follows. Water and cassava raw material are mixed well in a tank equipped with a stirrer, and then immersed for 12 hrs to remove impurities using a cyclone-type separator. The impurities-removed liquid is immersed in the tank for 12 hrs, and then small lumps are removed from the liquid using a sifter. Then, the resultant is passed through a cyclone-type separator to remove impurities. The starch liquid from which impurities are removed is concentrated using a centrifugal concentrator, and refined using a mini cyclone-type refining machine. The wet starch is dehydrated using a centrifugal dehydrator to have a water content of 30˜40%, and then dried by a pneumatic hot air blown into the pneumatic duct to have a water content of 13%.

A yeast extract powder is used as a flavor enhancer, instead of monosodium L-glutamate (MSG), and prepared by spraying a mixture of yeast extract liquid and excipients.

For the preparation of green tea seasoning salt, the leaves of green tea are collected and steamed using a steam cooker at 120° C. for 50 sec. After cooling, the leaves of green tea are softened to evaporated moisture, homogenized, and then dried in a conveyor to pass through a drier, resulting in semimanufactured goods having a water content of 4% or less. If necessary, the product is pulverized to a size of 250 mesh using an air pulverizer, screened, and finely pulverized to at least 90% passage through a 150 mesh. If the leaves of green tea are pulverized to a size of 80 mesh, the finished product does not have uniform appearance due to the coarse green tea powder.

A green tea extract powder is prepared as follows. The sprout or leaf of Camellia sinensis (the Theaceae family) is extracted with water or alcohol, filtered, concentrated by reverse osmosis, and then dried using a spray drier. The powdered material consists of 80% of green tea extract powder and 20% of dextrin. The green tea extract powder is a light yellow to brown fine powder, and has a typical flavor without abnormal taste and odor.

The tapioca starch and yeast extract powders are prepared in the same manners as in the above preparation method of powdered materials of garlic seasoning salt.

Each powdered material is weighed, and then mixed well using a ribbon mixer for 10˜30 min.

Step 3) is a step of preparing an adhesive gelatinized solution, in which a small amount of tapioca starch is added to water to prepare a gelatinized solution at a concentration of 0.1˜15% by weight. If the concentration of the gelatinized solution is higher than 15% by weight, feeding and spraying of the gelatinized solution are not readily carried out. If the concentration of the gelatinized solution is lower than 0.1% by weight, its binding capacity is decreased to increase the damage rate upon granulation.

Step 4) is a step of mixing a liquid material of garlic or green tea extract liquid with the gelatinized tapioca starch solution. The garlic or green tea extract liquid is prepared as follows.

For the preparation of garlic extract liquid, 9.45 kg of fresh onion are concentrated to prepare 1 kg of an onion extract. The anion extract consists of 63.1% of onion concentrate, 21.53% of sugar, 12.98% of water, 1.64% of glycerin, 0.41% of caramel, and 0.34% of a flavoring agent (dipropyl disulfide, methyl propyl disulfide, dipropyl trisulfide, dimethylpropyl trisulfide).

4˜5 kg of garlic are concentrated under vacuum to prepare 100 g of a garlic extract. The garlic extract consists of 99.9% of garlic extract and 0.1% of garlic essential oil. The garlic extract consists of 91.0% of glucose syrup, 8.0% of garlic extract, and 1.0% of ammonia caramel, and the garlic essential oil consists of 100% of garlic oil.

For the preparation of green tea extract liquid, a green tea concentrate is prepared by a series of process including extraction, concentration under vacuum, enzyme degradation, filtration, material blending, and concentration under vacuum. In particular, 2500 of purified water is added to 100 of green tea, extracted under heating at 93° C. or higher for 30 min, and then squeezed using a juicer, followed by concentration to 5 Brix. 0.1% of pectinase and 0.1% of amylase are added thereto, based on the weight of green tea, and enzyme degradation is performed at 50° C. for 4 hrs, followed by heating at 90° C. for 10 min for deactivation. The resultant is filtered using a pressure filter to obtain the green tea extract liquid. 10% of dextrin is added thereto, based on the weight of green tea extract liquid, and dissolved, followed by concentration under vacuum to 68 Brix or more. Thus, the green tea concentrated liquid consisting of 91% of green tea extract liquid and 9% of dextrin is prepared. The green tea concentrated liquid has a dark green color and a typical green tea flavor.

The gelatinized tapioca starch solution prepared in step 3) is cooled to 40˜60° C. and the liquid material of garlic or green tea extract liquid prepared by the above method is added to the gelatinized tapioca starch solution, followed by emulsification using a homomixer at a speed of 1000 to 2500 rpm. If the temperature of gelatinized tapioca starch solution is not reduced before mixing with the liquid material, the loss of flavor is increased, leading to deterioration of the product.

Step 5) is a step of granulating and drying the materials. The gelatinized tapioca starch solution and liquid material emulsified in step 4) are added to the powdered material prepared in step 2) by spraying, and homogenously mixed for a predetermined time in a fluidized bed dryer/lodige mixer/extrusion granulator to prepare granules. Various granulation techniques are as follows.

Fluidized Bed Granulation (SD Granulation)
LIQ/POW: 12˜15%,
Liquid injection speed: 60˜90 kg/hr,
Air flow: 7000 m³,
Spray pressure: 2.0 bar,
Temperature of top portion of dryer: 50˜75° C.
Temperature of bottom portion of dryer: 50˜105° C.
Concentration of gelatinized solution: 0.1˜15%.

Fluidized bed granulation is a method of preparing granules by spraying the gelatinized tapioca starch solution and liquid material onto the powdered material and drying while circulating in a fluidized bed dryer. Fluidized bed granulation is characterized in that the prepared granule has a low BD (bulk density) and a rough surface.

Lodige Mixer Granulation
Mixing time after liquid injection: 180˜240 sec,

If the mixing time is longer than 240 sec, agglomeration occurs. If the mixing time is shorter than 180 sec, granules are not easily formed.
Chopper operating time: 40˜120 sec,

The chopper functions to break agglomerated particles. If chopper operating time is longer than 120 sec, granule breakage occurs. If chopper operating time is shorter than 40 sec, agglomeration occurs.
LIQ/POW: 8˜12%,

If the LIQ/POW ratio is higher than 12%, agglomeration occurs. If the LIQ/POW ratio is lower than 8%, granules are not formed.
Concentration of gelatinized solution: 0.1˜15%,

If the concentration of gelatinized solution is higher than 15%, the liquid is hardly supplied and sprayed. If the concentration of gelatinized solution is lower than 0.1%, binding capacity is reduced to increase the damage rate upon granulation.

Lodige mixer granulation is a method of preparing granules by spraying the gelatinized tapioca starch solution and liquid material onto the powdered material, mixing them using a kneader to form granules, and then drying them in a fluidized bed dryer. Lodige mixer granulation is characterized in that the prepared granule has a high BD (bulk density) and a round shape.

Extrusion Granulation

Extrusion granulation is a method of preparing granules by spraying the gelatinized tapioca starch solution and liquid material onto the powdered material, mixing them using a kneader, passing through 1˜1.5 pi dome to form granules, and then drying them in a fluidized bed dryer, and sieving to obtain a desired size of granule. Extrusion granulation is characterized in that the prepared granule has a high BD (bulk density) and a uniform particle size.

As mentioned the above, the granulated seasoning salt prepared according to the present invention can be granulated into any desired type by using various granulation techniques.

The granulated garlic salt according to the present invention consists of 45˜65% by weight of refined salt, 12˜35% by weight of onion mixed powder, 8˜15% by weight of garlic mixed powder, 5˜15% by weight of sugar, 4˜8% by weight of lactose, 2˜5% by weight of tapioca starch, 1˜3% by weight of seasoning pepper powder, 1˜1.5% by weight of onion extract, 0.2˜0.8% by weight of yeast extract powder, and 0.2˜0.8% by weight of garlic extract. In the granulated garlic salt, the ingredients are not distinguished from each other with the naked eye, and have a homogeneous light yellow color.

The granulated green tea salt according to the present invention consists of 45˜65% by weight of refined salt, 10˜20% by weight of tapioca starch, 8˜12% by weight of sugar, 8˜12% by weight of green tea powder, 5˜10% by weight of lactose, 1˜3% by weight of green tea extract powder, 1˜3% by weight of green tea flavor, 1˜3% by weight of green tea concentrate, 0.5˜1% by weight of yeast extract powder, and 0.1˜0.3% by weight of Gardenia jasminoides colorant. In the granulated green tea salt, the ingredients are not distinguished from each other with the naked eye, and have a homogeneous green color.

Hereinafter, the preferred Examples are provided for better understanding. However, these Examples are for illustrative purposes only, and the invention is not intended to be limited by these Examples.

### MODE FOR INVENTION

### Example 1

### Preparation of Granulated Garlic Seasoning Salt Using Gelatinized Tapioca Starch Solution as Binder

The refined salt used for the preparation of garlic seasoning salt was pulverized using a mill, and lumps due to caking were removed to obtain a fine salt powder. Powdered materials including garlic mixed powder, onion mixed powder, seasoning pepper powder, yeast extract powder, tapioca starch, sugar and lactose were homogeneously mixed using a ribbon mixer for 10 to 30 min, and then homogeneously mixed with the pulverized refined salt using a mixer for 5 to 15 min. A small amount of tapioca starch, which was used as a binder and an anti-caking agent, was added to water, and dissolved to 5 to 15% by weight (w/w), followed by heating at 50 to 80° C. to prepare a gelatinized solution. Then, liquid materials including the garlic and onion extracts were added to the gelatinized solution, and emulsified using a homomixer at a speed of 1000 to 2500 rpm. The gelatinized tapioca starch solution and liquid material were sprayed onto the mixed powdered material, and homogenously mixed for a predetermined time in a fluidized bed dryer/lodige mixer/extrusion granulator to prepare granules, followed by drying. The dried product was passed through a −12˜+45 mesh screen to screen granules within a desired size range.

### Comparative Example 1

### Preparation of Granulated Garlic Seasoning Salt Using Water as Binder

The granulated garlic seasoning salt was prepared in the same manners as in Example 1, except for using water instead of the gelatinized tapioca starch solution as the binder and anti-caking agent in Example 1. The dried product was passed through a −12˜+45 mesh screen to screen granules within a desired size range.

### Comparative Example 2

### Preparation of Granulated Garlic Seasoning Salt by Simple Mixing

The granulated garlic seasoning salt was prepared by simple mixing in the same manners as in Example 1, except for using no gelatinized tapioca starch solution as the binder and anti-caking agent in Example 1. The dried product was passed through a −12˜+45 mesh screen to screen granules within a desired size range.

Yields of granulated garlic seasoning salts prepared in Example 1, and Comparative Examples 1 and 2 are shown in Table 1.

TABLE 1
Yield of granulated garlic seasoning salt

| | | | Comparative | Comparative |
|---|---|---|---|---|
| | | Example 1 | Example 1 | Example 2 |
| Input (g) | | 200.0 | 200.0 | 200.0 |
| Passage | 1 | 135.8 | 93.2 | 50.5 |
| through −12~+45 | 2 | 139.5 | 109.4 | 49.4 |
| mesh | 3 | 137.3 | 89.7 | 52.1 |
| | Mean | 137.5 | 97.4 | 50.7 |
| Yield (%) | | 68.76 | 48.72 | 25.33 |

As shown in Table 1, the granulated garlic seasoning salt prepared by using the gelatinized tapioca starch solution as the binder had a yield of 68.76% (Mn), whereas the granulated garlic seasoning salt prepared by using water as the binder had a yield of 48.72%, and the granulated garlic seasoning salt prepared by simple mixing had a yield of 25.33%. Accordingly, it can be seen that the gelatinized tapioca starch solution functions to increase binding capacity, so as to increase the yield of product.

### Example 2

### Preparation of Granulated Green Tea Seasoning Salt Using Gelatinized Tapioca Starch Solution as Binder

The refined salt used for the preparation of green tea seasoning salt was pulverized using a mill, and lumps due to caking were removed to obtain a fine salt powder. Powdered materials including green tea powder, green tea extract powder, yeast extract powder, tapioca starch, sugar and lactose were homogeneously mixed with the pulverized refined salt. Tapioca starch, which was used as a binder and an anti-caking agent, was added to water, and heated at 50 to 80° C. to prepare a gelatinized solution. Then, liquid materials including the green tea flavor and green tea concentrate were added to the gelatinized solution, and homogeneously mixed with each other. The gelatinized tapioca starch solution and liquid material were sprayed onto the mixed powdered material, and homogenously mixed for a predetermined time in a fluidized bed dryer/lodige mixer/extrusion granulator to prepare granules, followed by drying. The dried product was passed through a −12˜+45 mesh screen to screen granules within a desired size range.

### Comparative Example 3

### Preparation of Granulated Green Tea Seasoning Salt Using Water as Binder

The granulated green tea seasoning salt was prepared in the same manners as in Example 2, except for using water instead of the gelatinized tapioca starch solution as the binder and anti-caking agent in Example 2. The dried product was passed through a −12˜+45 mesh screen to screen granules within a desired size range.

### Comparative Example 4

### Preparation of Granulated Green Tea Seasoning Salt by Simple Mixing

The granulated green tea seasoning salt was prepared by simple mixing in the same manners as in Example 2, except for using no gelatinized tapioca starch solution as the binder and anti-caking agent in Example 2. The dried product was passed through a −12˜+45 mesh screen to screen granules within a desired size range.

Yields of granulated green tea seasoning salts prepared in Example 2, and Comparative Examples 3 and 4 are shown in Table 2.

TABLE 2
Yield of granulated green tea seasoning salt

| | | | Comparative | Comparative |
|---|---|---|---|---|
| | | Example 2 | Example 3 | Example 4 |
| Input (g) | | 200.0 | 200.0 | 200.0 |
| Passage | 1 | 120.6 | 82.7 | 18.1 |
| through −12~+45 | 2 | 131.6 | 98.7 | 17.8 |
| mesh | 3 | 157.9 | 103.3 | 18.6 |
| | Mean | 136.7 | 94.9 | 18.2 |
| Yield (%) | | 68.36 | 47.43 | 9.08 |

As shown in Table 2, the granulated green tea seasoning salt prepared by using the gelatinized tapioca starch solution as the binder had a yield of 68.36% (Mn), whereas the granulated green tea seasoning salt prepared by using water as the binder had a yield of 47.43%, and the granulated green tea seasoning salt prepared by simple mixing had a yield of 9.08%. Accordingly, it can be seen that the gelatinized tapioca starch solution functions to increase binding capacity, so as to increase the yield of product.

### Experimental Example 1

### Evaluation of Storage Stability-Caking Tendency

Each 50 g of the granulated garlic seasoning salts prepared in Example 1 and Comparative Examples 1 and 2, and the granulated green tea seasoning salts prepared in Example 2 and Comparative Examples 3 and 4 were packed in a glass bottle, and then the unsealed bottles were stored in a 45° C. 80% humid incubator for 4 weeks. Then, the bottles were turned upside down, and the amount of caked salt was quantified.

Caking tendency of the granulated garlic seasoning salt is shown in Table 3, and caking tendency of the granulated green tea seasoning salt is shown in Table 4.

TABLE 3
Yield of granulated garlic seasoning salt

| | | | Comparative | Comparative |
|---|---|---|---|---|
| | | Example 1 | Example 1 | Example 2 |
| Amount of | 1 | 29.21 | 35.54 | 49.90 |
| caked salt | 2 | 29.19 | 33.74 | 49.70 |
| (g) | 3 | 29.91 | 45.20 | 49.70 |
| | Mean | 36.10 | 38.16 | 49.77 |
| Caking | | 72.21 | 76.32 | 99.53 |
| tendency (%) | | | | |

TABLE 4
Yield of granulated green tea seasoning salt

| | | | Comparative | Comparative |
|---|---|---|---|---|
| | | Example 2 | Example 3 | Example 4 |
| Amount of | 1 | 38.20 | 43.96 | 49.85 |
| caked salt | 2 | 42.16 | 42.75 | 49.69 |
| (g) | 3 | 41.53 | 49.48 | 49.52 |
| | Mean | 40.63 | 45.40 | 49.69 |
| Caking | | 68.36 | 90.79 | 99.37 |
| tendency (%) | | | | |

As shown in Table 3, it can be seen that the granulated garlic seasoning salt (Example 1) prepared by using the gelatinized tapioca starch solution of the present invention as the binder and anti-caking agent has a lower caking tendency to exhibit better storage stability than the garlic seasoning salt (Comparative Example 1) prepared by using water as the binder and anti-caking agent and the garlic seasoning salt (Comparative Example 2) prepared by simple mixing.

In addition, as shown in Table 4, it can be seen that the granulated green tea seasoning salt (Example 2) prepared by using the gelatinized tapioca starch solution of the present invention as the binder and anti-caking agent has a lower caking tendency to exhibit better storage stability than the green tea seasoning salt (Comparative Example 3) prepared by using water as the binder and anti-caking agent and the green tea seasoning salt (Comparative Example 4) prepared by simple mixing.

### Experimental Example 2

### Evaluation of Caking Stability

Each of the granulated garlic seasoning salt prepared in Example 1 and the granulated green tea seasoning salt prepared in Example 2 was put in a glass bottle, and packaged as follows. The sealed bottles were stored under the conditions of 0° C., 25° C., 35° C., 45° C., 45° C./80% humidity and 55° C. for 14 days, followed by sieving using a vibratory sieve shaker for 30 sec.

The results are shown in Table 5.

<Packaging Conditions>

1) Uncapped bottle (opened bottle)

2) Recapped bottle with inner seal removed (in use)

3) Sealed bottle (packaged for sale)

TABLE 5

| | | | | | | | 45° C. | |
|---|---|---|---|---|---|---|---|---|
| | | | 0° C. | 25° C. | 35° C. | 45° C. | (80% humidity) | 55 |
| 1) | Garlic | −12 mesh (g) | 0 | 0 | 0 | 0 | 0.09 | 0 |
| Opened | seasoning | +12 mesh (g) | 60.93 | 53.5 | 53.28 | 54.89 | 51.87 | — |
| bottle | salt | Caking | 0.00 | 0.00 | 0.00 | 0.00 | 0.17 | 0.00 |
| | | tendency (%) | | | | | | |
| | Green tea | −12 mesh (g) | 0 | 0 | 0 | 0 | 1.15 | 0 |
| | seasoning | +12 mesh (g) | 57.74 | 52.53 | 52.36 | 49.46 | 55.39 | 51.21 |
| | salt | Caking | 0.00 | 0.00 | 0.00 | 0.00 | 2.03 | 0.00 |
| | | tendency (%) | | | | | | |
| 2) | Garlic | −12 mesh (g) | 0 | 0 | 0 | 0 | 1.5 | 0 |
| Recapped | seasoning | +12 mesh (g) | 59.79 | 55.57 | 52.33 | 50.81 | 54.66 | 52..26 |
| bottle | salt | Caking | 0.00 | 0.00 | 0.00 | 0.00 | 2.67 | 0.00 |
| (inner | | tendency (%) | | | | | | |
| seal | Green tea | −12 mesh (g) | 0 | 0 | 0 | 0 | 0 | 0 |
| removed) | seasoning | +12 mesh (g) | 58.35 | 53.09 | 52.64 | 52.19 | 54.1 | 51.54 |
| | salt | Caking | 0.00 | 0.00 | 0.00 | 0.00 | 0.00 | 0.00 |
| | | tendency (%) | | | | | | |
| 3) | Garlic | −12 mesh (g) | 0 | 0 | 0 | 0 | 0 | 0 |
| sealed | seasoning | +12 mesh (g) | 59.83 | 55.27 | 52.78 | 52.66 | 52.79 | 53.15 |
| bottle | salt | Caking | 0.00 | 0.00 | 0.00 | 0.00 | 0.00 | 0.00 |
| | | tendency (%) | | | | | | |
| | Green tea | −12 mesh (g) | 0 | 0 | 0 | 0 | 0 | 0 |
| | seasoning | +12 mesh (g) | 58.49 | 53.67 | 52.65 | 52.21 | 52.99 | 52.13 |
| | salt | Caking | 0.00 | 0.00 | 0.00 | 0.00 | 0.00 | 0.00 |
| | | tendency (%) | | | | | | |

As shown in Table 5, when the granulated garlic seasoning salt and granulated green tea seasoning salt according to the present invention were left under the temperature conditions for 14 days, water adsorption and agglomeration occurred. However, when a slight physical impact was applied to the bottles, the granulated garlic seasoning salt and granulated green tea seasoning salt of the present invention were disintegrated, indicating that they had excellent caking stability.

### Experimental Example 3

### Evaluation of Water Content

The granulated garlic seasoning salt prepared in Example 1, which was packed in a glass bottle as follows, was heated at 95° C. for 90 sec using a laboratory fluidized bed dryer (Fluid Bed Dryer, Fuji Paudal Co., Ltd.).

(1) Salt was packaged in a sealed bottle (water content 3.9%),

(2) Salt in sealed bottles was additionally dried at 75° C. for 40 min, and then repackaged in the sealed bottle (water content 3%).

When the sealed bottle (1) was heated at 95° C. for 90 sec, the granulated garlic seasoning salt therein absorbed moisture to become wet. After cooling, the granulated garlic seasoning salt was caked, but disintegrated by a slight physical impact.

In addition, salt in sealed bottles was additionally dried at 75° C. for 40 min, and repackaged in the sealed bottle (2). Then, the sealed bottle was heated at 95° C. for 90 sec. As a result, the granulated garlic seasoning salt therein did not absorb moisture, and thus caking did not occur.

As mentioned the above, the granulated garlic seasoning salt of the present invention had the water content of 3.9%. When the finished product was additionally dried to lower its water content by 3% or less, caking can be minimized during packaging process.

### Experimental Example 4

### Evaluation of Storage Stability Against Browning Reaction 1—Colorimetry

Under temperature conditions of 25° C., 35° C., 45° C., and 55° C., the granulated garlic seasoning salt prepared in Example 1 and the granulated green tea seasoning salt prepared in Example 2 were put in glass bottles. The opened bottle 1), the recapped bottle with inner seal removed 2), and the sealed bottle 3) were stored for 2 weeks, and then the color was measured. The color measurement was repeated three times using a color difference meter (JS555, Color techno system co, LTD). Measured values were expressed as Hunter color values of L value (lightness), a value (red/green), and b value (yellow/blue), and the distance between two points in Hunter color difference meter was calculated using the following Equation 1, by which spatial color difference and instrumental error can be compensated. Product quality standards are shown in Table 6.

Caking tendency of the granulated garlic seasoning salt is shown in Table 7, and caking tendency of the granulated green tea seasoning salt is shown in Table 8.

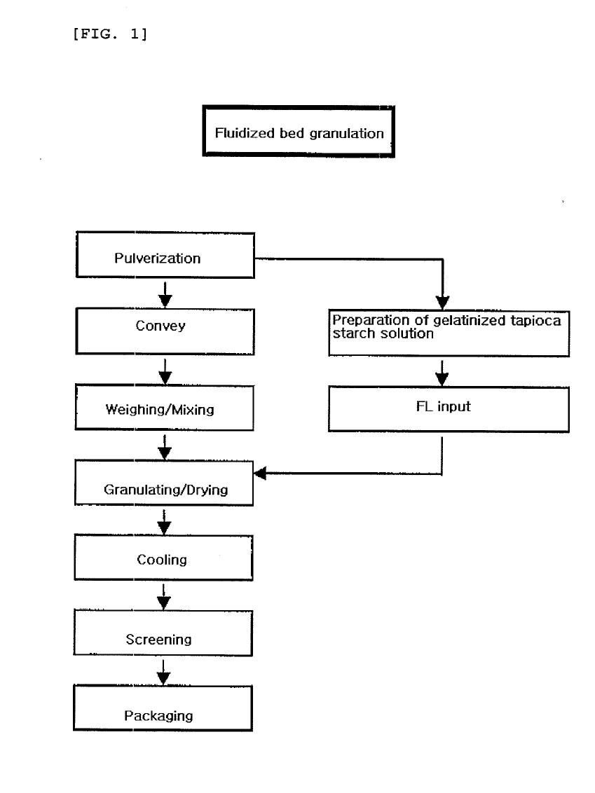

ΔE*ab=[ΔL2+Δa2+Δb2]1/2 [Math Figure 1]

TABLE 6
Product quality standards

| | |
|---|---|
| 0~0.5 | For imperceptible color difference |
| 0.5~1.5 | For a very small difference |
| 1.5~3.0 | For perceptible difference |
| 3.0~6.0 | For a significant difference |
| 6.0~12.0 | For a very significant difference |
| 12.0 or more | For distinct color |

TABLE 7
Caking tendency of granulated garlic seasoning salt

| | Opened bottle | | | | Recapped bottle (inner seal removed) | | | | Sealed bottle | | | |
|---|---|---|---|---|---|---|---|---|---|---|---|---|
| | L value | a value | b value | E value | L value | a value | b value | E value | L value | a value | b value | E value |
| standard | 51.08 | 4.49 | 20.62 | | 50.63 | 4.03 | 18.24 | | 52.62 | 4.00 | 18.74 | |
| | 50.48 | 3.81 | 18.45 | | 49.55 | 4.34 | 17.81 | | 52.90 | 4.19 | 19.10 | |
| | 50.78 | 4.15 | 19.54 | 0.00 | 50.09 | 4.19 | 18.03 | 0.00 | 52.76 | 4.10 | 18.92 | 0.00 |
| 25° C. | 51.33 | 3.92 | 18.22 | | 51.19 | 4.18 | 18.71 | | 53.14 | 3.76 | 18.25 | |
| | 50.93 | 3.80 | 18.25 | | 49.94 | 4.00 | 17.34 | | 53.11 | 4.12 | 19.00 | |
| | 51.13 | 3.86 | 18.24 | 1.38 | 50.57 | 4.09 | 18.03 | 1.53 | 53.13 | 3.94 | 18.63 | 2.52 |
| 35° C. | 51.23 | 3.88 | 19.18 | | 48.96 | 4.01 | 17.87 | | 50.39 | 4.16 | 18.49 | |
| | 51.50 | 4.09 | 18.37 | | 48.94 | 4.34 | 18.22 | | 50.45 | 3.86 | 18.49 | |
| | 51.37 | 3.99 | 18.78 | 0.97 | 48.95 | 4.18 | 18.05 | 2.36 | 50.42 | 4.01 | 18.49 | 1.11 |
| 45° C. | 49.73 | 3.88 | 17.66 | | 49.59 | 3.63 | 17.23 | | 49.72 | 4.39 | 18.97 | |
| | 51.36 | 3.85 | 18.10 | | 50.83 | 3.97 | 18.46 | | 49.59 | 4.37 | 18.87 | |
| | 50.55 | 3.87 | 17.88 | 1.70 | 50.21 | 3.80 | 17.85 | 1.82 | 49.66 | 4.38 | 18.92 | 1.30 |
| 55° C. | 51.24 | 3.90 | 17.69 | | 52.68 | 4.37 | 20.07 | | 50.82 | 4.59 | 18.54 | |
| | 50.39 | 4.23 | 17.79 | | 51.45 | 3.86 | 18.07 | | 49.05 | 4.91 | 19.22 | |
| | 50.82 | 4.07 | 17.74 | 1.80 | 52.07 | 4.12 | 19.07 | 1.37 | 49.94 | 4.75 | 18.88 | 1.23 |

TABLE 8
Caking tendency of granulated green tea seasoning salt

| | Opened bottle | | | | Recapped bottle (inner seal removed) | | | | Sealed bottle | | | |
|---|---|---|---|---|---|---|---|---|---|---|---|---|
| | L value | a value | b value | E value | L value | a value | b value | E value | L value | a value | b value | E value |
| standard | 32.12 | −5.15 | 13.25 | | 33.03 | −5.23 | 13.56 | | 31.87 | −4.80 | 12.36 | |
| | 31.33 | −4.99 | 12.48 | | 32.38 | −4.95 | 12.77 | | 32.21 | −4.89 | 12.79 | |
| | 31.73 | −5.07 | 12.87 | 0.00 | 32.71 | −5.09 | 13.17 | 0.00 | 32.04 | −4.85 | 12.58 | 0.00 |
| 25° C. | 32.60 | −5.14 | 13.28 | | 32.07 | −4.90 | 12.36 | | 31.41 | −4.65 | 12.04 | |
| | 31.90 | −4.98 | 12.50 | | 32.12 | −4.83 | 12.54 | | 30.14 | −4.68 | 11.21 | |
| | 32.25 | −5.06 | 12.89 | 0.53 | 32.10 | −4.87 | 12.45 | 0.59 | 30.78 | −4.67 | 11.63 | 1.61 |
| 35° C. | 32.17 | −4.41 | 12.26 | | 32.29 | −4.31 | 12.44 | | 31.76 | −4.26 | 12.41 | |
| | 31.73 | −4.51 | 12.32 | | 31.38 | −4.45 | 12.32 | | 32.31 | −4.48 | 13.04 | |
| | 31.95 | −4.46 | 12.29 | 0.87 | 31.84 | −4.38 | 12.38 | 0.85 | 32.04 | −4.37 | 12.73 | 0.78 |
| 45° C. | 31.58 | −4.17 | 11.82 | | 32.77 | −4.15 | 12.60 | | 32.51 | −4.13 | 12.85 | |
| | 31.61 | −4.08 | 11.54 | | 31.96 | −4.22 | 12.22 | | 31.88 | −4.05 | 12.57 | |
| | 31.60 | −4.13 | 11.68 | 1.52 | 32.37 | −4.19 | 12.41 | 1.18 | 32.20 | −4.09 | 12.71 | 1.10 |
| 55° C. | 31.38 | −3.98 | 11.62 | | 33.64 | −4.35 | 13.59 | | 32.16 | −3.93 | 12.72 | |
| | 32.77 | −4.20 | 12.87 | | 33.24 | −4.24 | 13.58 | | 32.00 | −3.81 | 12.62 | |
| | 32.08 | −4.09 | 12.25 | 1.21 | 33.44 | −4.30 | 13.59 | 2.02 | 32.08 | −3.87 | 12.67 | 1.27 |

As shown in Tables 7 and 8, the granulated garlic seasoning salt and the granulated green tea seasoning salt of the present invention had ΔE values of 0.97˜2.52 and 0.53˜2.02, respectively. That is, the results showed a very small difference. Therefore, the granulated garlic seasoning salt and the granulated green tea seasoning salt of the present invention were found to exhibit excellent storage stability against browning reaction.

### Experimental Example 5

### Evaluation of Storage Stability Against Browning Reaction 2—Measurement of Color Change

The granulated garlic seasoning salt prepared in Example 1 and the granulated green tea seasoning salt prepared in Example 2 were put in glass bottles. Then, each of the opened bottles was stored at 0° C. and 55° C. for 14 days, and color change was measured.

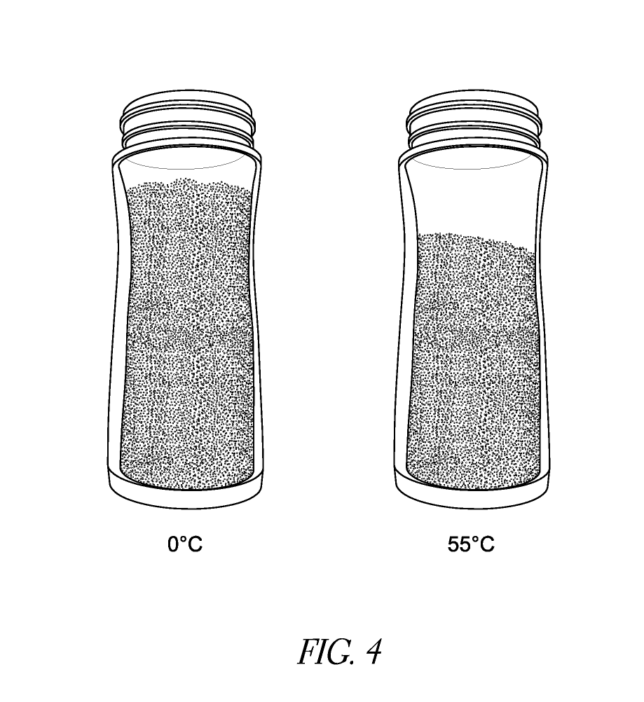

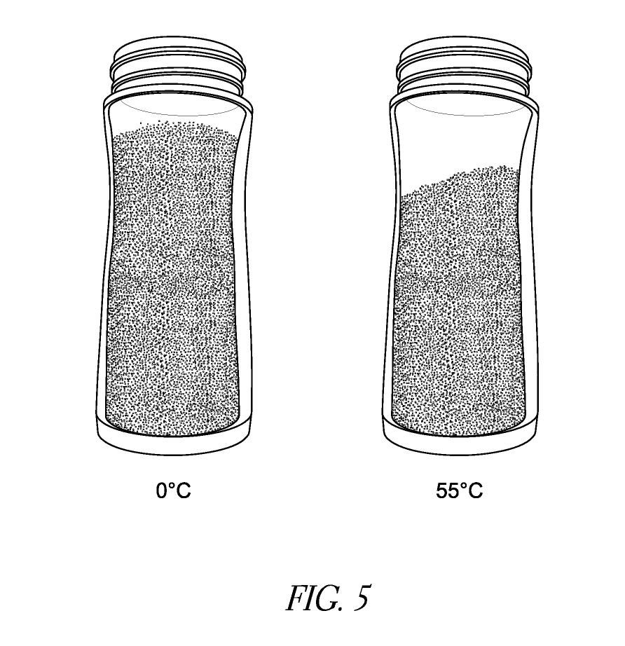

Color change of granulated garlic seasoning salt is shown in FIG. 4, and color change of granulated green tea seasoning salt is shown in FIG. 5.

As shown in FIGS. 4 and 5, the granulated garlic seasoning salt and the granulated green tea seasoning salt of the present invention did not turn brown under harsh condition of high temperature (55° C.) for 2 weeks.

### Experimental Example 6

### Sensory Evaluation and Evaluation of User Satisfaction

1. Sensory Evaluation

250 women were randomly selected from 25˜49 year old-married women who reside in Seoul, and subjected to sensory evaluation on the granulated garlic seasoning salt prepared in Example 1 and the granulated green tea seasoning salt prepared in Example 2. Each item was evaluated using a 5-point scoring system (5: very good, 4: good, 3: moderate, 2: fair, 1: bad), and the results are expressed as mean values

The results are shown in Table 9.

TABLE 9

| | | | | | Particle | | |
|---|---|---|---|---|---|---|---|
| | First | | | | size of | Salty | |
| | taste | Color | Texture | Aftertaste | salt | taste | Flavor |
| Example 1 | 3.72 | 4.13 | 3.69 | 3.70 | 3.67 | 3.68 | 3.46 |
| Example 2 | 3.64 | 4.08 | 3.68 | 3.66 | 3.76 | 3.69 | 3.33 |

As shown in Table 9, high scores were given for the granulated garlic seasoning salt and granulated green tea seasoning salt of the present invention in each item of sensory evaluation, in particular, excellent in the items of first taste and color satisfaction.

2. Evaluation of User Satisfaction

250 women were randomly selected from 25˜49 year old-married women who reside in Seoul, and survey of user satisfaction with the granulated garlic seasoning salt prepared in Example 1 and the granulated green tea seasoning salt prepared in Example 2 was performed. Evaluation items include grilled fresh pork, seasoned vegetables, soups, stews, stirred dishes, egg dishes, and roasted dishes.

The results are shown in Table 10.

TABLE 10

| | Grilled | Seasoned | | | Stirred | Egg | Roasted |
|---|---|---|---|---|---|---|---|
| | fresh pork | vegetables | Soups | Stews | dishes | dishes | dishes |
| Example 1 | 3.72 | 4.14 | 3.46 | 3.83 | 4.0 | 3.50 | 4.00 |
| Example 2 | 3.64 | 3.25 | 4.67 | 4.14 | 3.33 | 3.89 | 4.39 |

As shown in Table 10, a high average score of 4.14 (on a five-point scale) was given for the seasoned vegetables with the granulated garlic seasoning salt of the present invention, whereas a low average score of 3.46 was given for soups seasoned with the granulated garlic seasoning salt of the present invention. In addition, a low average score of 3.25 was given for the seasoned vegetables with the granulated green tea seasoning salt of the present invention, whereas a high average score of 4.67 was given for soups seasoned with the granulated green tea seasoning salt of the present invention. Therefore, it was found that seasoning preference depends on cooking method.

### Experimental Example 7

### Measurement of Density

The density of granulated garlic seasoning salt prepared in Example 1 and granulated green tea seasoning salt prepared in Example 2 was measured.

The results are shown in Table 11.

TABLE 11

| Number | Example 1 | Example 2 |
|---|---|---|
| 1 | 43.54 | 41.94 |
| 2 | 44.40 | 41.74 |
| 3 | 44.04 | 42.03 |
| 4 | 42.23 | 41.43 |
| 5 | 45.63 | 41.87 |
| Mean | 43.97 | 41.80 |
| BD (bulk density) | 0.44 | 0.42 |

### Experimental Example 8

### Measurement of Salinity Measurement

The salinity of granulated garlic seasoning salt prepared in Example 1 and granulated green tea seasoning salt prepared in Example 2 was measured.

The results are shown in Table 12.

TABLE 12

| | Example 1 | Example 2 |
|---|---|---|
| Dilution | 43.54 | 41.94 |
| Salt meter | 44.40 | 41.74 |
| Salt meter | 44.04 | 42.03 |
| Mean | 42.23 | 41.43 |
| Salinity 1 | 45.63 | 41.87 |
| Salinity 2 | 43.97 | 41.80 |
| Mean | 0.44 | 0.42 |

### INDUSTRIAL APPLICABILITY

The granulated seasoning salt according to the present invention is prepared by using a gelatinized tapioca starch solution as a binder and an anti-caking agent to solve the problem such as caking property due to moisture absorption. Thus, the prepared seasoning salt has high binding capacity and stability, does not turn brown, is rapidly eluted, and can be stored for a long period of time without dissociation of the mixed materials. In addition, prepared by adding active ingredients such as garlic and green tea to the salt, simultaneous intake of garlic and salt is simply accomplished by use of the garlic salt, and simultaneous intake of catechin is simply accomplished by use of the green tea salt.

1. A granulated seasoning salt comprising salt particles, a seasoning ingredient, and a binder comprising gelatinized tapioca starch.

2. The granulated seasoning salt according to claim 1, wherein the seasoning ingredient comprises at least one selected from the group consisting of garlic, green tea, sea tangle, mushroom, onion, mugwort, pine needle, lemon and medicinal herbs.

3. The granulated seasoning salt according to claim 2, wherein the granulated seasoning salt is a granulated garlic seasoning salt.

4. The granulated seasoning salt according to claim 2, wherein the granulated seasoning salt is a granulated green tea seasoning salt.

5. The granulated seasoning salt according to claim 1, wherein the granulated seasoning salt is granulated by a method selected from the group consisting of:
fluidized bed granulation;
lodige mixer granulation; and
extrusion granulation.

6. A preparation method of granulated seasoning salt, comprising:
mixing a liquid component and a non-liquid component to provide a mixture, wherein the liquid component comprises gelatinized tapioca starch, and the non-liquid component comprises salt, wherein the mixture further comprises a seasoning ingredient as part of at least one of the liquid component and the non-liquid component;
granulating the mixture; and
drying the granulated mixture.

7. The preparation method according to claim 6, further comprising:
providing the liquid component, which comprises adding tapioca starch to water to prepare a gelatinized solution at a concentration of 0.1-15% by weight.

8. The method of claim 6, wherein the seasoning ingredient comprises at least one selected from the group consisting of garlic, green tea, sea tangle, mushroom, onion, mugwort, pine needle, lemon and medicinal herbs.

9. The method of claim 6, wherein said granulating is done by a method selected from the group consisting of:
fluidized bed granulation;
lodige mixer granulation; and
extrusion granulation.
